(19) United States
(12) Patent Application Publication
(10) Pub. No.: US 2008/0109391 A1
(43) Pub. Date: May 8, 2008

(54) Classifying content based on mood

(75) Inventor: Arthur Chan, Cambridge, MA (US)

Correspondence Address: Trellis Intellectual Property Law Group, PC, 1900 EMBARCADERO ROAD, SUITE 109, PALO ALTO, CA, 94303, US

(73) Assignee: ScanScout, Inc., Cambridge, MA (US)

(21) Appl. No.: 11/594,714

(22) Filed: Nov. 7, 2006

(51) Int. Cl. G06N 5/00

(52) U.S. Cl. 706/45

(57) ABSTRACT

In one embodiment, content and events are received. The content is analyzed based on to determine a mood score based on events. The mood score is used to classify the content and event with a mood. The mood classification may then be used to affect actions being performed. For example, the mood may affect ad matching to the content. In one example, depending on the mood that is calculated, different ads may be matched to different portions of the content. Accordingly, more effective ads may be served with the content when the mood classification is taken into account.

### BACKGROUND

Embodiments of the present invention generally relate to classification of content based on mood.

When a user is watching some kind of content, not only is the user receiving information from the content, but the content may invoke some feeling about the content. For example, the feeling of anger, joy, etc. may be felt depending on the content being viewed. This feeling may also vary between users. Sometimes, depending on this feeling, a user may decide whether or not to keep viewing the content.

### SUMMARY

Embodiments of the present invention generally relate to classifying content based on a mood calculation. In one embodiment, content and events are received. The content is analyzed based on to determine a mood score based on events. The mood score is used to classify the content and event with a mood. The mood classification may then be used to affect actions being performed. For example, the mood may affect ad matching to the content. In one example, depending on the mood that is calculated, different ads may be matched to different portions of the content. Accordingly, more effective ads may be served with the content when the mood classification is taken into account.

In one embodiment, a method for analyzing content is provided. The method comprises: determining a portion of the content; determining an event; determining one or more models that include statistical information for modeling a mood; and analyzing the portion of the content to determine a mood score based on the event using the one or more models, wherein the mood score is usable to provide mood information about the portion of content and the event.

In another embodiment, an apparatus is provided that comprises: one or more processors; and logic encoded in one or more tangible media for execution by the one or more processors and when executed operable to: determine a portion of content; determine an event; determine one or more models that include statistical information for modeling a mood; and analyze the portion of the content to determine a mood score based on the event using the one or more models, wherein the mood score is usable to provide mood information about the portion of content and the event.

A further understanding of the nature and the advantages of particular embodiments disclosed herein may be realized by reference of the remaining portions of the specification and the attached drawings.

### BRIEF DESCRIPTION OF THE DRAWINGS

FIG. 1 depicts a simplified system for classifying content according to mood according to one embodiment of the present invention.

FIG. 2 shows different models that may be used to determine a mood score according to one embodiment of the present invention.

FIG. 3 depicts a simplified flowchart of a method for determining a mood score according to one embodiment of the present invention.

FIG. 4 depicts a simplified system for serving advertisements with content according to one embodiment of the present invention.

### DETAILED DESCRIPTION OF EMBODIMENTS

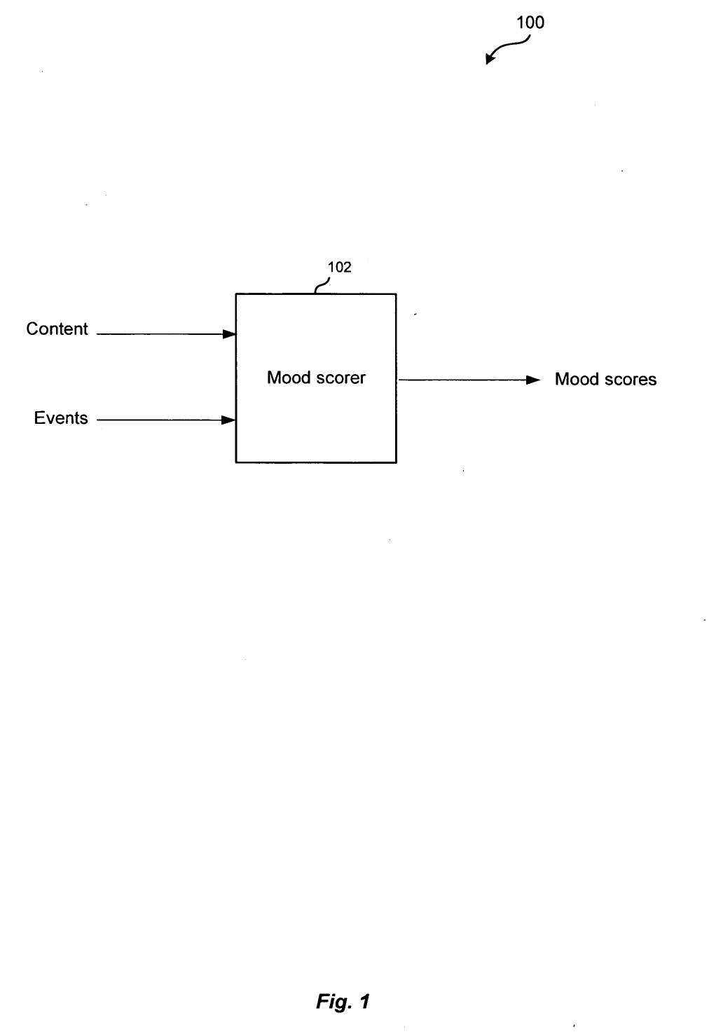

FIG. 1 depicts a simplified system 100 for classifying content according to mood according to one embodiment of the present invention. As shown, a mood scorer 102 receives content and one or more events, and is configured to generate a mood score. In one embodiment, a mood score for each of the events received may be generated. The mood score can be used to classify the content. For example, it may be determined that the event and a portion of the content may invoke a sad mood.

The content may be any type of information, such as text, rich media content, etc. Text content may include news or transcripts of rich media content, web pages, books, stories, papers, etc. Rich media content may include content that includes the elements of audio (e.g., speech), video, animation, special effects, and/or user interactivity features. Although this type of content is described, it will be understood that any type of information may be analyzed.

An event may be any information that is taken in association with the content to determine a mood invoked from the content and/or the event. For example, the event may include an advertisement, keywords, concepts, images, text, items in the content, etc.

A mood may be any affective behavior expressed by human beings that invoke an emotion. For example, an emotion may be happiness, sadness, anger, depression, frustration, annoyance, hopefulness, etc. The moods may apply to both affective behavior to a human act on events or to the human him/herself.

Mood is human oriented and may differ from human to human. The mood may be the subjective judgment or point of view of a human being. The mood may differ based on various factors, such as background, geographic location, age, lifestyle, personality, experience, religion, philosophy, faith, or simple thoughts of humans. Mood may be self-reflective or caused by other events. Mood may be subjective but the mechanism to generate it may also be affected by human pondering on that particular situation.

Mood may also include disputatiousness, which is how controversial a piece of content is. For example, a piece of content on the latest research on stem cells may easily cause dispute.

Particular embodiments analyze content and classify the content with a mood score that can be used to infer a mood. In one embodiment, an event may be associated with a portion of the content. The content and the event may be analyzed to determine a mood that may be invoked from the portion of the content. For example, if the event is an advertisement being shown with a portion of the content, mood scorer 102 determines what kind of mood may be invoked by the advertisement/content pair. This information may be used to determine if the ad should be shown with the portion of content. If multiple events are associated with the portion of content, then the mood scorer may be used to select one of the events. For example, the ad that invokes the best mood associated with the content may be selected to be the ad shown with that portion of content.

The mood scores may be generated for various events and multiple portions of content. For example, a certain scene in a video may invoke different moods for different events. Mood scorer 102 may analyze the scene using the one or more models to generate a mood score for all of the content/event pairs. The mood score may be used to classify the scene with a mood for all of the events. For example, it may be determined that the scene invokes a mood of anger or happiness for the different events. If the events are advertisements, the advertisement that invokes a mood score that indicates the happiest mood may be selected as an advertisement to show with that scene.

Although a mood score is discussed, it will be understood that the mood score may be any indication of a mood classification. For example, the mood score may actually be a mood, such as anger, sadness, etc. In other embodiments, the mood score may be a raw number that may be used to determine a mood classification. Different applications may also interpret mood scores differently. For example, one application may interpret a high mood score as being good and another may consider it bad. This may be the case when one advertiser wants to invoke a bad mood and wants a mood score that indicates a bad mood is invoked.

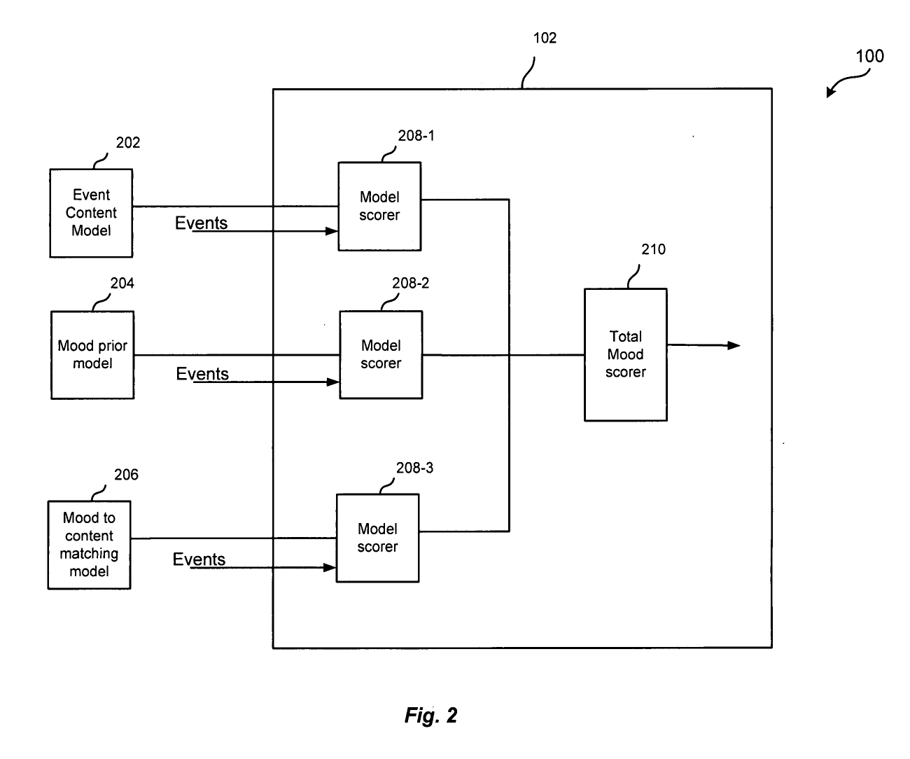

One or more models may be used to determine the mood score. FIG. 2 shows different models that may be used to determine a mood score according to one embodiment of the present invention. As shown, an event content matching model 202, a mood prior model 204, and a mood to content matching model 206 are provided. It will be understood that other models may be appreciated, such as any other statistical models.

Mood scorer 102 includes different model scorers 208 that may determine a model score for using each model. Although individual model scorers 208 are shown, it will be understood that any number of model scorers may be used to determine a score for a model.

Model scorer 208-1 receives an event content matching model 202 and an event, and is configured to generate an event content matching model score. Event content matching model 202 is the probability of how likely a mood may result based on an event and content pair.

A content and event pair may be separately categorized using the mood-to-content classifier. For example, the content and/or event may be good or bad. This leaves four possibilities:

content=good and event=good;
content=good and event=bad;
content=bad and content=good; and
content=bad and event=bad

Whether the content or event may be considered good or bad may be a mood. Given the above possibilities, event content matching model 202 predicts the probability that a mood may result if the possibility occurs. For example, given that the content is considered good and the event is considered good, event content matching model 202 is used to determine the probability that a good mood may be invoked.

Mood prior model 204 is a model of how often user may have certain moods. For example, given a set of content, how often a mood may be invoked for that content is modeled. For example, mood prior model 204 may include a set of pre-specified labels. One example may be happy, sad, angry, disputatious, or not disputatious. Other labels of moods may also be appreciated.

In one embodiment, the user may annotate moods that are invoked based on content. Then, the percentage of each mood is determined where the percentage may be a parameter value in mood prior model 204. Though pre-annotation is discussed, it will be understood that data will not be limited to pre-annotated data but may also be dynamically generated data, web based data, etc.

An estimate of the probability that a mood may occur may be the ratio of the number of times a mood occurs based on a total number of portions of content analyzed. For example, if a mood occurs in a large number of people, then the estimation that that mood may occur for that portion of content may be greater.

In another embodiment, when no pre-existing data exists, then the moods may be equally weighted. That is, there is an equal chance that any mood may occur.

When mood prior model 204 is used, model scorer 208-2 may receive an event and use the model to generate a likelihood that a mood may occur. This likelihood is determined irrespective of the content. When a mood score is determined for content, mood prior model 204 determines how likely it is that a certain mood may be invoked. Mood prior model 204 is different from event content matching model 202 because mood prior model 204 does not take into account the content and/or event that a mood score is being determined for.

Mood to content matching model 206 is a model that when given a mood, the probability that certain content is being generated is modeled. For example, if a portion of content is used, mood to content matching model 206 may be used to generate a mood that may most likely occur for that content.

Certain classifiers may be used where the content may be run through them and a mood may be generated. For example, the following methods may be used: naïve Bayes family classifiers, SVM-based classifiers, Rocchio algorithms, maximum entropy methods, Markov random field methods, neural networks, etc.

A network may be trained with information. The content may be run through the network and a mood score may be generated. In one example of a classifier, any combination of words and categories of words in any order may be used. Linear or non-linear transformation of features may also be a type of feature. For example, unigram, bi-gram, tri-gram, and general N-gram features may be used. A unigram may be one word, bi-gram may be combination of two words, a tri-gram may be combination of three words, and so forth. The n-gram features may include any order of words. Also, the words may be mapped to classes such as nouns, verbs and other categories. Also, an expanded term vector for the N-gram vector may be used. However, the expansion mechanism may be any latent semantic indexing or any co-occurrence finders.

A statistical model may be generated based on the above classifiers. For example, using the naïve Bayes family of classifier, estimates of the unigram probability of a word by computing the ratio of the word to the total occurrence of words may be used. When text from a portion of content is specified, a mood to content matching model score is computed by multiplying all the unigram probabilities together. For example, the unigram possibility may be a word. The mood score generated by mood to content matching model 206 may depend on how many times the word occurs in the content. If a bi-gram feature is used, the mood score may depend on how many times the combination of the two words occurs.

Also, mood to content matching model 206 may model the probability a mood may occur based on an event instead of the content. For example, keywords for the event may be run though the classifier to model the mood that may be invoked for the event. For example, if an ad is associated with keywords, mood to content matching model 206 may model a mood that may be invoked for those keywords.

In one embodiment, data collection for mood to content matching model 206 is performed. For example, an automatic method of data collection is provided. In this case, given a certain type of mood, a set of keywords is specified that represents this mood. Then, searches of content, such as articles, for that keyword are performed and used as training material. The selection may be performed in a sentence-based, paragraph-based, or article-based manner.

Also, moods that are invoked by users may already be annotated in the content. For example, moods may be specified by users, such as on websites such as Livejournal.com, Xanga.com, Myspace.com, etc.

User feedback may also be used in mood to content matching model 206. For example, for each keyword an advertiser bids for, there may be a list of keywords that is provided to the advertiser. The advertiser is then asked for a rating for each of these words. The rating may be a mood, such as good/bad, or it may be a mean opinion score. Given these values, the estimate of mood scores for the keywords may be adjusted and this estimate is used to interpolate mood to content matching model 206.

Different methods of collecting user feedback may be used. For example, user clicks could be tracked to provide further information as to which keywords are more popular, users may be asked if keywords should be blacklisted (keywords that should be not be associated with an event (e.g., an advertisement)), users may be asked to provide suggestions of anti-keywords, etc.

Mood to content matching model 206 may then be adjusted using the user's feedback. For example, using the naïve Bayes classification method, the scores for certain keywords may be skewed based on the feedback. For example, a weighted sum of unigram scores with any probability estimates drawn from the user's feedback, a cache-based language model, and a maximum entropy-based method may be adjusted. When there is a new word, different words may be added into mood to content matching model 206. For example, a word may be inserted into the nth rank of the features and the probability normalized for the word to 1. A null method in which no adaptation may also be included in mood to content matching model 206.

Mood to content matching model 206 may also be adapted based on the behavior of individual users or a group of users. For example, any side information such as geographical, behavioral, or demographical information may be used to adapt mood to content matching model 206. For example, text from a certain population group (e.g. specified by geographic information) may be used to re-train the mood to content matching model 206. If certain words invoke different emotions in a geographic area, this may be taken into account and used to train the network for mood to content matching model 206. Also, the model trained may be interpolated with a generic model to generate a model to use with a certain group of users.

Each mood scorer 208 may receive the event and use its model to determine a mood score for the event. Each mood scorer 208 (in some cases, not all mood scorers may be used) sends a mood score to total mood scorer 210. Total mood scorer 210 may weight the different mood scores from different models. For example, different models may be weighted differently depending on the event. For example, some models may be considered more relevant for a content/event pair than others. A sum of the weighted mood scores is then generated. For example, the equation weight #1×log(Event content matching mood score)+weight #2×log(mood prior model mood score)+weight #3×log(mood to content matching model mood score), where “x” is a multiplication and the log is the logarithm of the mood score generated by each model. It will be understood that other methods and equations of determining a total mood score will be appreciated.

The total mood score may be used to indicate a mood for the event. For example, a higher mood score may indicate a mood that is good, but a lower mood score may indicate a mood that is bad. Based on the score, an action may be taken. For example, if the mood score leans more toward the bad side of a mood, then it may be determined that the event should not be used with a portion of content. If the event was an advertisement and it received a mood score indicating a bad mood is invoked for a portion of content, then it may be decided that the ad should not be displayed with the portion of content. In one embodiment, if multiple events are scored for the same portion of content, then the most favorable mood score may be used to select the event. For example, out of five events, if one event received the highest mood score indicating that this invoked the emotion “good”, then that event may be selected. In one example, the advertisement that invoked the best mood may be displayed with that part of the content.

A blacklist may also be used to determine the mood score. For example, a list of keywords may be generated for a mood. Although a list of words is used, it could also be other things, such as a combination of words, categories of words, bi-gram, tri-gram, etc.

In one embodiment, an entity may not want their brand to show up against certain keywords that indicate a disfavorable mood. For example, the mood may be bad when a keyword is encountered. This may be different across different entities. The blacklist would ensure that a negative mood score is provided for that advertiser when the keyword shows up. In one example, a certain car company lays off 30,000, the blacklist keyword may be “layoff”. Thus, when the keyword “layoff” is encountered and is coupled with the car company's ad, then a mood score that indicates the keyword is blacklisted may be generated. In this case, then the car company's advertisement may not be shown with the portion of content that includes the keyword “layoff”.

A graphical user interface (GUI) for blacklist keyword feedback may be provided. In this case, a user may provide inputs for keywords used in generating a blacklist for the models. The graphical user interface may provide a list of keywords (not all of them may necessarily be blacklisted). Users may provide feedback based on the keywords. For example, users may indicate by a “yes” or “no” whether the word should be blacklisted or not. Also, users may give an opinion score as to how likely the keyword may actually be a blacklisted word.

Also, the interface may provide a list of blacklisted keywords where a user may give a “yes” or “no” as to whether they should be blacklisted or not. Also, opinion scores may be provided on how likely the keyword should be a blacklisted keyword.

Further, a list of dissimilar keywords to a keyword may be provided. Users may give feedback as to whether these keywords should be blacklisted or not. Further, opinion scores as to how likely the keyword is actually a blacklisted keyword may be provided. Using a list of dissimilar keywords provides a more robust list of keywords that should or should not be blacklisted.

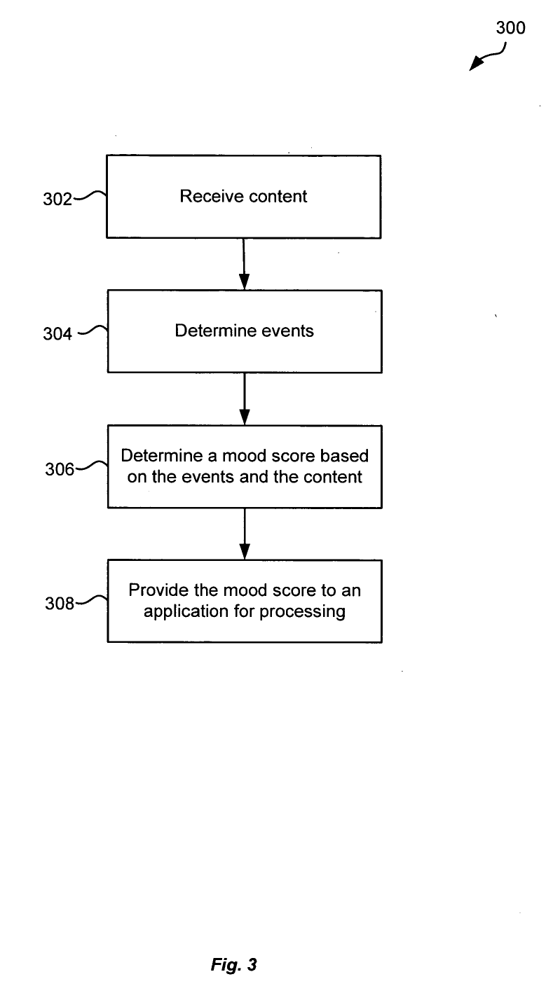

FIG. 3 depicts a simplified flowchart of a method for determining a mood score according to one embodiment of the present invention. Step 302 receives content. The content may be received for determining if advertisements should be displayed with portions of the content. Although advertisements are discussed, it will be understood that any event may be used in place of the advertisements.

Step 304 determines events. One or more events may be determined, such as a list of advertisements. The list of advertisements may be advertisements that may be possibly shown with the content.

Step 306 determines a mood score based on the events and the content. For example, for each event and a portion of the content, a mood score is determined. Accordingly, multiple moods scores are generated for each event/content pair.

Step 308 provides the mood score to an application for processing. For example, the application may then determine which advertisements to display with which portions of content based on the mood scores. In one embodiment, an application may take the mood score that indicates the most desirable mood, such as a good mood, that is invoked by an event and portion of content. The highest score out of all the events is then taken and that event is used.

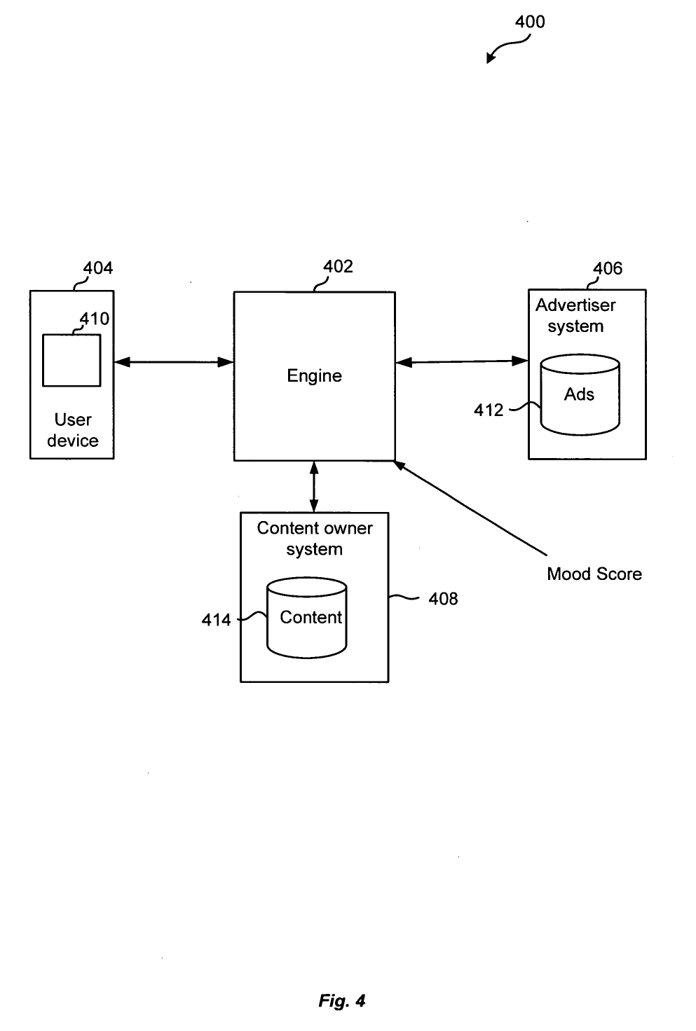

FIG. 4 depicts a simplified system 400 for serving advertisements with content according to one embodiment of the present invention. As shown, an engine 402, user device 404, advertiser system 406, and content owner system 408 are provided. Which advertisements that are served may be determined based on the mood determined. For example, during the playing of content, different advertisements may be rendered (displayed, played, etc.) with portions of the content. Engine 402 may determine which advertisements to serve with the content.

Engine 402 may be any device/system that provides serving of advertisements to user device 404. In one embodiment, engine 402 correlates advertisements to subject matter associated with content. Accordingly, an advertisement that correlates to the subject matter associated with the portion of content may be served such that it can be rendered on user device 404 relative to the portion of content. Different methods may be used to correlate or match advertisements to portions of the content. For example, U.S. patent application Ser. No. ______, entitled “TECHNIQUES FOR RENDERING ADVERTISMENTS WITH RICH MEDIA”, filed concurrently, and incorporated by reference in its entirety for all purposes, describes methods of correlating advertisements to subject matter associated with a portion of content. Any other suitable correlation or matching techniques may be used.

Advertiser system 406 provides advertisements from advertisement database 412. Advertisements may be any content. For example, advertisements may include information about the advertiser, such as the advertiser's products, services, etc. Advertisements include but are not limited to elements possessing text, graphics, audio, video, animation, special effects, and/or user interactivity features, uniform resource locators (URLs), presentations, targeted content categories, etc. In some applications, audio-only or image-only advertisements may be used.

Advertisements may include non-paid recommendations to other links/content within the site or to other sites. The advertisement may also be data from the publisher (other links and content from them) or data from a servicer of engine (e.g., from its own data sources (such as from crawling the web)), or some other 3^{rd} party data sources. The advertisement may also include coupons, maps, ticket purchase information, or any other information.

Advertiser system 406 provides advertisements to engine 402. Engine 402 may then determine which advertisements to serve from advertisement content 412 to user device 404.

Content owner system 408 provides content stored in content database 444 to engine 402 and user device 404. Content may include but is not limited to content that possesses elements of audio, video, animation, special effects, and/or user interactivity features. For example, the content may be a streaming video, a stock ticker that continually updates, a pre-recorded web cast, a movie, Flash™ animation, slide show, or other presentation. The content may be provided through a web page or through any other methods, such as streaming video, streaming audio, pod casts, etc.

User device 404 may be any device. For example, user device 404 includes a computer, laptop computer, personal digital assistant (PDA), cellular telephone, set-top box and display device, digital music player, etc. User device 404 includes a display 410 and a speaker (not shown) that may be used to render content and/or advertisements.

Advertisements may be served from engine 402 to user device 404. User device 404 then can render the advertisements. Rendering may include the displaying, playing, etc. of content. For example, video and audio may be played where video is displayed on display 410 and audio is played through a speaker (not shown). Also, text may be displayed on display 410. Thus, rendering may be any output of content on user device 402.

In one embodiment, the advertisements are correlated to a portion of the content. The advertisement can then be displayed relative to that portion in time. For example, the advertisement may be displayed in serial, parallel, or be injected into the content.

The correlation may be determined based on the mood score generated for advertisements (events) and a portion of the content. For example, engine 402 may receive multiple advertisements and determine which one should be correlated to the portion of the content. The advertisements that are received may be first determined to be relevant based on keyword matching. For example, if a keyword appears in the content, certain advertisements may be associated with that keyword. These may be advertisements for different entities or the same entity. Engine 402 then determines which advertisement should be correlated to the portion of content based on the mood scores that are determined for each advertisement. Other factors may also be used to determine which advertisement to correlate, such as the amount bid for placing the ad, etc.

When the advertisement is determined, it is served to user device 404. User device 404 can then render the advertisement at the appropriate time. For example, the advertisement may be rendered with the portion of content.

Accordingly, using an expected mood, better matches of advertisements to content may be determined. For example, if it is determined that a good mood is invoked by an advertisement/content pair, then it might be better to render that advertisement more so than an advertisement that might invoke a bad mood when rendered with the content. This may produce better results for the advertisement. For example, it may be more likely that a user may select (click) on an advertisement when viewing the content if he/she is put in a good mood. Conversely, if the advertisement/content pair invokes a bad mood, then the advertiser might not want to be paired with the content and thus bad pairings are avoided.

Although the description has been described with respect to particular embodiments thereof, these particular embodiments are merely illustrative, and not restrictive.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. Functions can be performed in hardware, software, or a combination of both. Unless otherwise stated, functions may also be performed manually, in whole or in part.

In the description herein, numerous specific details are provided, such as examples of components and/or methods, to provide a thorough understanding of particular embodiments. One skilled in the relevant art will recognize, however, that a particular embodiment can be practiced without one or more of the specific details, or with other apparatus, systems, assemblies, methods, components, materials, parts, and/or the like. In other instances, well-known structures, materials, or operations are not specifically shown or described in detail to avoid obscuring aspects of particular embodiments.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory.

Particular embodiments can be implemented in the form of control logic in software or hardware or a combination of both. The control logic, when executed by one or more processors, may be operable to perform that what is described in particular embodiments:

A “processor” or “process” includes any human, hardware and/or software system, mechanism or component that processes data, signals, or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, “a specific embodiment”, or “particular embodiment” means that a particular feature, structure, or characteristic described in connection with the particular embodiment is included in at least one embodiment and not necessarily in all particular embodiments. Thus, respective appearances of the phrases “in a particular embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other particular embodiments. It is to be understood that other variations and modifications of the particular embodiments described and illustrated herein are possible in light of the teachings herein and are to be considered as part of the spirit and scope.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, an and “the” includes plural references unless the context clearly dictates otherwise. Also, as used in the description herein and throughout the claims that follow, the meaning of “in” includes “in” and “on” unless the context clearly dictates otherwise.

The foregoing description of illustrated particular embodiments, including what is described in the Abstract, is not intended to be exhaustive or to limit the invention to the precise forms disclosed herein. While specific particular embodiments of, and examples for, the invention are described herein for illustrative purposes only, various equivalent modifications are possible within the spirit and scope, as those skilled in the relevant art will recognize and appreciate. As indicated, these modifications may be made to the present invention in light of the foregoing description of illustrated particular embodiments and are to be included within the spirit and scope.

Thus, while the present invention has been described herein with reference to particular embodiments thereof, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit. It is intended that the invention not be limited to the particular terms used in following claims and/or to the particular embodiment disclosed as the best mode contemplated for carrying out this invention, but that the invention will include any and all particular embodiments and equivalents falling within the scope of the appended claims.

We claim:

1. A method for analyzing content, the method comprising:
determining a portion of the content;
determining an event;
determining one or more models that include statistical information for modeling a mood; and
analyzing the portion of the content to determine a mood score based on the event using the one or more models, wherein the mood score is usable to provide mood information about the portion of content and the event.

2. The method of claim 1, wherein the event comprises an advertisement, the method further comprising determining if the advertisement should be matched to the portion of content based on the mood score.

3. The method of claim 1, wherein the one or more models comprise a mood prior model, mood to content model, and/or an event content matching model.

4. The method of claim 1, wherein the mood information comprises an emotion.

5. The method of claim 1, wherein the mood information comprises information on whether the content and the event are disputatious or not disputatious.

6. The method of claim 1, wherein the mood score is determined based on sub-mood scores determined from analyzing the portion of content and the event using each of the one or more models individually.

7. The method of claim 1, wherein analyzing the portion of the content comprising determining if the portion of content includes one or more blacklist keywords, wherein the mood score is adjusted based on if the portion of content includes a blacklist keyword in the one or more blacklist keywords.

8. The method of claim 7, wherein the event is not matched to the portion of content if it includes the blacklist keyword.

9. The method of claim 1, further comprising:
comparing the mood score for the event to one or more mood scores for one or more other events; and
selecting one of the event or the one of the one or more other events that has the most favorable mood score.

10. The method of claim 9, wherein the selected event is selected to be used as an advertisement associated with the portion of content.

11. An apparatus comprising:
one or more processors; and
logic encoded in one or more tangible media for execution by the one or more processors and when executed operable to:
determine a portion of content;
determine an event;
determine one or more models that include statistical information for modeling a mood; and
analyze the portion of the content to determine a mood score based on the event using the one or more models, wherein the mood score is usable to provide mood information about the portion of content and the event.

12. The apparatus of claim 11, wherein the event comprises an advertisement, the logic further operable to determine if the advertisement should be matched to the portion of content based on the mood score.

13. The apparatus of claim 11, wherein the one or more models comprise a mood prior model, mood to content model, and/or an event content matching model.

14. The apparatus of claim 11, wherein the mood information comprises an emotion.

15. The apparatus of claim 11, wherein the mood information comprises information on whether the content and the event are disputatious or not disputatious.

16. The apparatus of claim 11, wherein the mood score is determined based on sub-mood scores determined from analyzing the portion of content and the event using each of the one or more models individually.

17. The apparatus of claim 11, wherein the logic is operable to determine if the portion of content includes one or more blacklist keywords, wherein the mood score is adjusted based on if the portion of content includes a blacklist keyword in the one or more blacklist keywords.

18. The apparatus of claim 17, wherein the event is not matched to the portion of content if it includes the blacklist keyword.

19. The apparatus of claim 11, wherein the logic is further operable to:
compare the mood score for the event to one or more mood scores for one or more other events; and
select one of the event or the one of the one or more other events that has the most favorable mood score.

20. The apparatus of claim 19, wherein the selected event is selected to be used as an advertisement associated with the portion of content.
